(19) United States
(12) Patent Application Publication
(10) Pub. No.: US 2024/0399294 A1
(43) Pub. Date: Dec. 5, 2024

(54) CARBON DIOXIDE ABSORBENT COMPOSITION AND METHOD FOR CAPTURING CARBON DIOXIDE USING THE SAME

(71) Applicant: KOREA INSTITUTE OF ENERGY RESEARCH, Daejeon (KR)

(72) Inventors: Sung Chan NAM, Daejeon (KR); Jong Tak JANG, Daejeon (KR); Il Hyun BAEK, Daejeon (KR)

(73) Assignee: KOREA INSTITUTE OF ENERGY RESEARCH, Daejeon (KR)

(21) Appl. No.: 18/529,269

(22) Filed: Dec. 5, 2023

(30) Foreign Application Priority Data
May 30, 2023 (KR) 10-2023-0068991

(51) Int. Cl. B01D 53/14; B01D 53/62; B01D 53/78

(52) U.S. Cl. CPC B01D 53/1493; B01D 53/1475; B01D 53/62; B01D 53/78; B01D 2252/20421; B01D 2252/20431; B01D 2252/20484; B01D 2252/602; B01D 2257/504

(57) ABSTRACT

The present invention relates to an absorbent having improved carbon dioxide capture performance of an amine solution to which a reaction accelerator is added and a method for manufacturing the same, specifically relates to an absorbent in which an amine solution is mixed with a primary amine containing an aromatic ring as an active additive that can improve the absorption rate to improve both the absorption performance and the absorption rate, and a method for manufacturing the same. According to an embodiment of the present invention, it is possible to provide an absorbent, which exhibits excellent CO₂ capture performance and has a higher absorption rate, a higher absorption capacity, and lower heat of absorption than an absorbent used in the conventional CO₂ capture process by combining a tertiary amine with a primary amine and DEEA used as a tertiary alkanol amine can be manufactured from agricultural products or residues, which are renewable resources, so the final absorbent can be manufactured at low cost, and the present invention can be usefully used as a technology that can reduce energy demand in the field of CO₂ capture and storage.

### FIELD OF THE INVENTION

The present invention relates to a carbon dioxide absorbent composition and a method for capturing carbon dioxide using the same, specifically relates to a composition having improved carbon dioxide absorption performance and absorption rate by adding a primary amine as a reaction accelerator to a main absorbent, and a method for capturing carbon dioxide using the same.

### DESCRIPTION OF THE RELATED ART

The Earth's climate is warming by emission of greenhouse gases, particularly carbon dioxide (CO₂) due to fossil fuel combustion. Therefore, interest in controlling greenhouse gas emissions using the carbon dioxide capture, utilization, and storage (CCUS) technology is increasing worldwide to mitigate climate change. The chemical CO₂ absorption process using organic amines, that is, the gas-liquid separation process, in the post-combustion CO₂ capture process (combustion exhaust gases and the like from coal-fired power plants and the like) is well known and has been mentioned in several studies. The most commonly used amines in the post-combustion CO₂ capture process using organic amines are primary amines (monoethanolamine, MEA), secondary amines (diethanolamine, DEA), tertiary amines (N-methyldiethanolamine, MDEA), diamines (piperazine, PZ), and sterically hindered amines (2-amino-2-methylpropanol, AMP). Primary amines and secondary amines are known to have fast absorption rates due to high reaction activity, and have high regeneration energy due to formation of thermally stable carbamates, while tertiary amines are known to have a large absorption capacity and a low regeneration energy consumption.

According to the results of previous studies, when the absorption performance of tertiary amines having a concentration of 30 wt. % has been evaluated and compared to an existing tertiary absorbent N-methyldiethanolamine (MDEA), N-diethylethanolamine (DEEA) has been investigated as a preferred amine over the tertiary amine MDEA since DEEA has a higher absorption rate, a higher absorption capacity, and lower heat of absorption. In a study for evaluating the equilibrium solubility, secondary reaction rate constant, and heat of CO₂ absorption of five tertiary amines through modeling, DEEA has been found to be the absorbent having the best CO₂ capture performance among the five amines.

A suitable CO₂ absorbent has three main characteristics of a high CO₂ solubility, low energy required for regeneration, and fast kinetics of CO₂ and amines. However, as mentioned earlier, tertiary amines have the disadvantage of a slow absorption rate. Therefore, absorbents of which the absorption rate is improved by combining the advantages of primary and secondary amines with the advantages of tertiary amines have received attention in recent years, and these blended absorbents have better absorption performance than single absorbents.

The increase in absorption rate of blended absorbents of primary and secondary amines and tertiary amines is associated with carbamate formation. The production of carbamates in these blend absorbents can be interpreted through nuclear magnetic resonance (NMR). NMR is an analysis that can effectively explain the liquid phase behavior of an absorbent in the CO₂ chemical absorption process using amines. NMR analysis of speciation has been performed in many studies to elucidate the liquid phase behavior in CO₂ absorption using organic amines.

Alkanol tertiary amines have properties of a high absorption capacity, a large cyclic capacity, a high boiling point and low heat of reaction and can be thus used as absorbents, and among these, DEEA has a large pKa value (9.73 at 298 K), thus can act as a strong proton acceptor during CO₂ absorption, and has the advantage of being manufactured from agricultural products and/or residues, which are renewable resources. Therefore, it is very important to select an appropriate absorbent and use an absorbent mixed with active additives that can increase the absorption performance and absorption rate.

### SUMMARY OF THE INVENTION

The present invention has been devised to solve the above-described problems, and an embodiment of the present invention provides a carbon dioxide absorbent composition containing a reaction accelerator and a main absorbent.

Another embodiment of the present invention provides a method for capturing carbon dioxide.

Still another embodiment of the present invention provides a method for manufacturing a carbon dioxide absorbent composition containing a reaction accelerator and a main absorbent.

The technical objects to be achieved by the present invention are not limited to the technical objects mentioned above, and other technical objects that are not mentioned will be clearly understood by those skilled in the art to which the present invention pertains from the description below.

As a technical means for achieving the above-described technical objects, an aspect of the present invention provides a carbon dioxide absorbent composition containing a main absorbent and a reaction accelerator, in which the main absorbent is a tertiary alkanol amine and the reaction accelerator is a primary amine.

The primary amine may contain an aromatic ring.

The primary amine may be represented by RNH₂, where R may be a substituted or unsubstituted aliphatic hydrocarbon group or a substituted or unsubstituted aromatic hydrocarbon group, and the substituent may be any one of an alkyl group, an aryl group, an alkoxy group, an aryloxy group, an acyloxy group, a halogen atom, an acylamino group, an acyl group, an alkylthio group, an arylthio group, a hydroxy group, a cyano group, an alkyloxycarbonyl group, an aryloxycarbonyl group, a substituted carbamoyl group, a substituted sulfamoyl group, a nitro group, a substituted amino group, an alkylsulfonyl group, an arylsulfonyl group, a substituted alkylsulfonamide group, or a substituted arylsulfonamide group.

The tertiary alkanol amine may have a pKa value in a range of 7.0 to 11.0.

The tertiary alkanol amine may be selected from the group consisting of N,N-bis-(3-dimethylaminopropyl)-N-(2-hydroxypropyl-octadecyl ether)amine, N-(3-dimethylaminopropyl)-N-(2-hydroxypropyl-octadecyl ether)amine, N,N-bis-(3-dimethylaminopropyl)-N-(2-hydroxypropyl-hexadecyl ether)amine, N-(3-dimethylaminopropyl)-N-(2-hydroxypropyl-hexadecyl ether)amine, N,N-bis-(3-dimethylaminopropyl)-N-(2-hydroxypropyl-tetradecyl ether)amine, N-(3-dimethylaminopropyl)-N-(2-hydroxypropyl-tetradecyl ether)amine, N,N-bis-(3-dimethylaminopropyl)-N-(2-hydroxypropyl-dodecyl ether)amine, N-(3-dimethylaminopropyl)-N-(2-hydroxypropyl-dodecyl ether)amine, N,N-bis-(3-dimethylaminopropyl)-N-(2-hydroxypropyl-decyl ether)amine, N-(3-dimethylaminopropyl)-N-(2-hydroxypropyl-decyl ether)amine, N,N-bis-(3-dimethylaminopropyl)-N-(2-hydroxypropyl-octyl ether)amine, N-(3-dimethylaminopropyl)-N-(2-hydroxypropyl-octyl ether)amine, N,N-bis-(3-dimethylaminopropyl)-N-(2-hydroxypropyl-2-ethylhexyl ether)amine, N-(3-dimethylaminopropyl)-N-(2-hydroxypropyl-2-ethylhexyl ether)amine, N,N-bis-(3-dimethylaminopropyl)-N-(2-hydroxypropyl-hexyl ether)amine, N-(3-dimethylaminopropyl)-N-(2-hydroxypropyl-hexyl ether)amine, N,N-bis-(3-dimethylaminopropyl)-N-(2-hexanol)amine, N-(3-dimethylaminopropyl)-N-(2-hexanol)amine, N,N-bis-(3-dimethylaminopropyl)-N-(2-octanol)amine, N-(3-dimethylaminopropyl)-N-(2-octanol)amine, N,N-bis-(3-dimethylaminopropyl)-N-(2-decanol)amine, N-(3-dimethylaminopropyl)-N-(2-decanol)amine, N,N-bis-(3-dimethylaminopropyl)-N-(2-dodecanol)amine, N-(3-dimethylaminopropyl)-N-(2-dodecanol)amine, N,N-bis-(3-dimethylaminopropyl)-N-(2-tetradecanol)amine, N-(3-dimethylaminopropyl)-N-(2-tetradecanol)amine, N,N-bis-(3-dimethylaminopropyl)-N-(2-hexadecanol)amine, N-(3-dimethylaminopropyl)-N-(2-hexadecanol)amine, N,N-bis-(3-dimethylaminopropyl)-N-(2-octadecanol)amine, N-(3-dimethylaminopropyl)-N-(2-octadecanol)amine, N,N-bis-(3-dimethylaminopropyl)-N-(2-hydroxypropyl-butyl ether)amine, N,N-bis-(3-dimethylaminopropyl)-N-(2-hydroxypropylneodecanoic acid ester)amine, N-methyldiethanolamine, dimethylethanolamine, N,N-diethylethanolamine, triethanolamine, and mixtures thereof.

A mixture of the reaction accelerator and the main absorbent may be contained at 30 to 50 parts by weight with respect to 100 parts by weight of the composition.

The reaction accelerator may be contained at 1 to 10 parts by weight with respect to 100 parts by weight of the composition.

The main absorbent may be contained at 30 to 50 parts by weight with respect to 100 parts by weight of the composition.

Another aspect of the present invention provides a method for capturing carbon dioxide using the carbon dioxide absorbent composition, which includes introducing the composition into a reactor in a vapor liquid equilibrium (VLE) device; introducing carbon dioxide into the reactor after a temperature and a pressure in the reactor have reached equilibrium; and stirring the reactor to react the composition with carbon dioxide.

The temperature in the reactor may be maintained at 300 to 400 K, and the stirring may be performed at a speed of 800 to 1,000 rpm.

A carbon dioxide absorption capacity captured by the method for capturing carbon dioxide may be 0.4 to 1.0 mole-CO₂/mole-Amine, an apparent absorption rate may be determined by time for a reaction of the carbon dioxide absorbent composition with carbon dioxide to reach equilibrium, and the time to reach equilibrium may be 7 to 40 minutes, heat of absorption of the carbon dioxide absorbent composition may be −80 to −60 kJ/mol·K, and a cyclic capacity may be 0.2 to 0.5 mole-CO₂/mole-Amine.

Still another aspect of the present invention provides a method for manufacturing the carbon dioxide absorbent composition, which includes mixing a reaction accelerator and a main absorbent to prepare a mixture; and stirring the mixture for activation.

The composition may contain a main absorbent and a reaction accelerator, the main absorbent may be a tertiary alkanol amine, and the reaction accelerator may be a primary amine.

A mixture of the reaction accelerator and the main absorbent may be contained at 30 to 50 parts by weight with respect to 100 parts by weight of the composition.

### BRIEF DESCRIPTION OF THE DRAWINGS

FIG. 1 illustrates main mechanism of a CO₂ capture reaction of an absorbent according to an embodiment of the present invention;

FIG. 2 illustrates information and characteristics of amines used in an embodiment of the present invention;

FIG. 3 illustrates compositions and abbreviations of amine solutions according to an embodiment of the present invention;

FIG. 4 illustrates a schematic diagram of a CO₂ capture device;

FIG. 5 illustrates a graph showing measurement results of CO₂ solubility in an AMP 30 wt % solution at 313 K using a vapor liquid equilibrium (VLE) device;

FIG. 6 illustrates graphs showing measurement results of CO₂ solubility in D40, D35P5, and D30P10 at 313 K, 333 K, 353 K, and 373 K;

FIG. 7 illustrates chemical structures of MEA, AMP, DEEA, and PEA according to an embodiment of the present invention;

FIG. 8 illustrates a schematic diagram of a VLE device according to an embodiment of the present invention;

FIG. 9 illustrates CO₂ gas partial pressure (kPa) results after measurement of CO₂ solubility in D40, D35P5, and D30P10 at 313 K, 333 K, 353 K, and 373 K;

FIG. 10 illustrates a result graph showing a change in pressure due to CO₂ absorption over time after injection of CO₂ into a VLE device reactor at 313 K;

FIG. 11 illustrates a graph showing heat of absorption of D40, D35P5, D30P10, and MEA;

FIG. 12 illustrates a schematic diagram for comparing absorption capacity (CO₂ equilibrium loading) and cyclic capacity of D40, D35P5, D30P10 and MEA 30 wt %;

FIG. 13 illustrates molecular species that can be produced in a DEEA-CO₂—H₂O system and a DEEA-PEA-CO₂—H₂O system;

FIG. 14 illustrates ¹³C NMR spectrum measurement results of D40;

FIG. 15 illustrates ¹³C NMR spectrum measurement results of D35P5;

FIG. 16 illustrates ¹³C NMR spectrum measurement results of D30P10; and

FIG. 17 illustrates results of chemical shifts and peak areas in ¹³C NMR spectra of D40, D35P5, and D30P10 solutions at 25° C.

### DETAILED DESCRIPTION OF THE PREFERRED EMBODIMENTS

Hereinafter, the present invention will be described in more detail. However, the present invention can be implemented in various different forms, and the present invention is not limited to the embodiments described herein and is only defined by the claims to be described later.

In addition, the terms used in the present invention are only used to describe specific embodiments and are not intended to limit the present invention. Singular expressions include plural expressions unless the context clearly dictates otherwise. In the entire specification of the present invention, ‘including’ a certain component means that other components may be further included rather than excluding other components, unless specifically stated to the contrary.

Throughout the specification, when a part is said to be “connected (linked, in contact, combined)” with another part, this includes not only the cases where they are “directly connected”, but also the cases where they are “indirectly connected” with another member in between. Additionally, when a part “includes” a certain component, this means that the part may be further equipped with other components rather than excluding other components, unless specifically stated to the contrary.

The terms used in the present specification are only used to describe specific embodiments and are not intended to limit the present invention. Singular expressions include plural expressions unless the context clearly dictates otherwise.

A first aspect of the present application provides a carbon dioxide absorbent composition containing a main absorbent and a reaction accelerator, in which the main absorbent is a tertiary alkanol amine and the reaction accelerator is a primary amine.

Hereinafter, the carbon dioxide absorbent composition according to the first aspect of the present application will be described in detail.

In an embodiment of the present application, the primary amine may be represented by RNH₂, where R may be a substituted or unsubstituted aliphatic hydrocarbon group or a substituted or unsubstituted aromatic hydrocarbon group, and the substituent may be any one of an alkyl group, an aryl group, an alkoxy group, an aryloxy group, an acyloxy group, a halogen atom, an acylamino group, an acyl group, an alkylthio group, an arylthio group, a hydroxy group, a cyano group, an alkyloxycarbonyl group, an aryloxycarbonyl group, a substituted carbamoyl group, a substituted sulfamoyl group, a nitro group, a substituted amino group, an alkylsulfonyl group, an arylsulfonyl group, a substituted alkylsulfonamide group, or a substituted arylsulfonamide group, and phenethylamine (PEA) may be preferably used. PEA is an aromatic amine and has the advantage of having a high boiling point (195° C.) and low energy required for CO₂ desorption.

In an embodiment of the present application, the tertiary alkanol amine may have a high absorption capacity, a high cyclic capacity, a high boiling point, and low heat of reaction when absorbing CO₂, may have a pKa value in the range of 7.0 to 11.0 so as to act as a proton acceptor, and may be selected from the group consisting of N,N-bis-(3-dimethylaminopropyl)-N-(2-hydroxypropyl-octadecyl ether)amine, N-(3-dimethylaminopropyl)-N-(2-hydroxypropyl-octadecyl ether)amine, N,N-bis-(3-dimethylaminopropyl)-N-(2-hydroxypropyl-hexadecyl ether)amine, N-(3-dimethylaminopropyl)-N-(2-hydroxypropyl-hexadecyl ether)amine, N,N-bis-(3-dimethylaminopropyl)-N-(2-hydroxypropyl-tetradecyl ether)amine, N-(3-dimethylaminopropyl)-N-(2-hydroxypropyl-tetradecyl ether)amine, N,N-bis-(3-dimethylaminopropyl)-N-(2-hydroxypropyl-dodecyl ether)amine, N-(3-dimethylaminopropyl)-N-(2-hydroxypropyl-dodecyl ether)amine, N,N-bis-(3-dimethylaminopropyl)-N-(2-hydroxypropyl-decyl ether)amine, N-(3-dimethylaminopropyl)-N-(2-hydroxypropyl-decyl ether)amine, N,N-bis-(3-dimethylaminopropyl)-N-(2-hydroxypropyl-octyl ether)amine, N-(3-dimethylaminopropyl)-N-(2-hydroxypropyl-octyl ether)amine, N,N-bis-(3-dimethylaminopropyl)-N-(2-hydroxypropyl-2-ethylhexyl ether)amine, N-(3-dimethylaminopropyl)-N-(2-hydroxypropyl-2-ethylhexyl ether)amine, N,N-bis-(3-dimethylaminopropyl)-N-(2-hydroxypropyl-hexyl ether)amine, N-(3-dimethylaminopropyl)-N-(2-hydroxypropyl-hexyl ether)amine, N,N-bis-(3-dimethylaminopropyl)-N-(2-hexanol)amine, N-(3-dimethylaminopropyl)-N-(2-hexanol)amine, N,N-bis-(3-dimethylaminopropyl)-N-(2-octanol)amine, N-(3-dimethylaminopropyl)-N-(2-octanol)amine, N,N-bis-(3-dimethylaminopropyl)-N-(2-decanol)amine, N-(3-dimethylaminopropyl)-N-(2-decanol)amine, N,N-bis-(3-dimethylaminopropyl)-N-(2-dodecanol)amine, N-(3-dimethylaminopropyl)-N-(2-dodecanol)amine, N,N-bis-(3-dimethylaminopropyl)-N-(2-tetradecanol)amine, N-(3-dimethylaminopropyl)-N-(2-tetradecanol)amine, N,N-bis-(3-dimethylaminopropyl)-N-(2-hexadecanol)amine, N-(3-dimethylaminopropyl)-N-(2-hexadecanol)amine, N,N-bis-(3-dimethylaminopropyl)-N-(2-octadecanol)amine, N-(3-dimethylaminopropyl)-N-(2-octadecanol)amine, N,N-bis-(3-dimethylaminopropyl)-N-(2-hydroxypropyl-butyl ether)amine, N,N-bis-(3-dimethylaminopropyl)-N-(2-hydroxypropylneodecanoic acid ester)amine, N-methyldiethanolamine, dimethylethanolamine, N,N-diethylethanolamine, triethanolamine, and mixtures thereof, and N,N-diethylethanolamine may be preferably used. When the absorption rate and absorption capacity of tertiary amines are compared, N,N-diethylethanolamine has the advantage of having a higher absorption rate, a higher absorption capacity, lower heat of absorption, and superior CO₂ capture performance compared to N-methyldiethanolamine, a conventionally used tertiary absorbent. In addition, N,N-diethylethanolamine has a large pKa value (9.73 at 298 K) so as to act as a strong proton acceptor during CO₂ absorption, and has the advantage of being manufactured from agricultural products and/or residues, which are renewable resources.

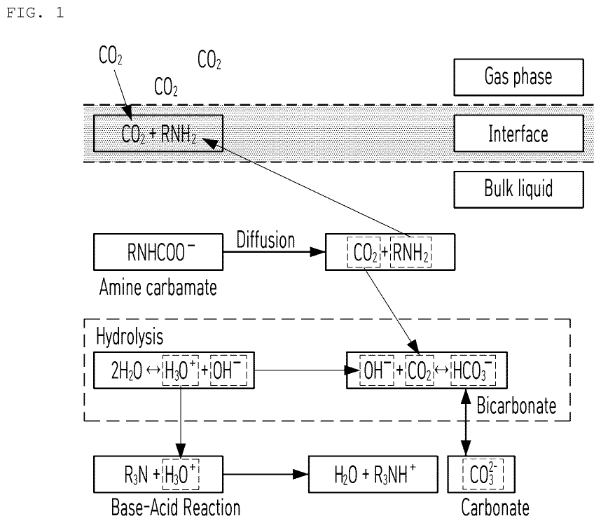

However, since the absorption rate of tertiary amines alone is slow, absorbents exhibiting improved absorption performance can be provided by combining tertiary amines with primary or secondary amines. The increase in absorption rate by combination of primary or secondary amines with tertiary amines is associated with carbamate formation. Carbamate production in such blended absorbents can be interpreted through NMR analysis. FIG. 1 illustrates the main mechanism of the CO₂ capture reaction of the absorbent according to an embodiment of the present invention, in which the amount of tertiary amine reacting with CO₂ at the interface is ignored and only the primary amine reacting with CO₂ at the interface is depicted.

CO₂ absorption by the absorbent according to an embodiment of the present invention can be explained by a shuttle mechanism. Referring to FIG. 1, the two amines both react with CO₂ at the gas-liquid interface, but the amount of primary amine decreases at the interface more rapidly than the amount of tertiary amine because of higher reactivity of primary amine. The primary amine reacted with CO₂ forms a carbamate to regenerate and diffuse CO₂ into the bulk solution. Additionally, the diffused CO₂ quickly reacts with the tertiary amine, and the carbamate acts as a CO₂ shuttle that diffuses a free primary amine to the surface so that the free primary amine can recapture CO₂. This mass transfer reaction of primary amine promotes the reaction of a tertiary amine with CO₂, and the absorption rate increases when this cycle is repeated.

In order to explain the main chemical reactions in the DEEA-H₂O—CO₂ system and the DEEA-PEA-H₂O—CO₂ system, first, look at the main chemical reactions during CO₂ absorption in an aqueous solution, including the following reactions:

### Ionization Reaction of Water:

2H₂O⇄H₃⁺O+OH⁻ (1)

### Decomposition Reaction of Carbon Dioxide:

CO₂+2H₂O⇄HCO₃⁻+H₃O⁺ (2)

### Decomposition of Bicarbonate Ion:

HCO₃⁻+H₂O⇄CO₃²⁻+H₂O⁺ (3)

### Conversion of Carbonate Ion:

CO₂+CO₃²⁻+H₂O⇄2HCO₃⁻ (4)

The main chemical reactions in the DEEA-H₂O—CO₂ system and the DEEA-PEA-H₂O—CO₂ system include:

Reaction of Primary Amine with CO₂:

PEA+CO₂⇄PEAH⁺COO⁻ (5)

PEAH⁺COO⁻+H₂O⇄PEACOO⁻+H₃⁺O (6)

PEAH⁺COO⁻+OH⁻⇄PEACOO⁻+H₂O (7)

### Proton Reaction of Primary Amine Nitrogen Atom:

PEAH⁺COO⁻+PEA⇄PEACOO⁻+PEAH⁺ (8)

PEACOO⁻+H₂O⇄HCO₃⁻+PEAH⁺ (9)

PEACOO⁻+OH⁻⇄HCO₃⁻+PEA (10)

PEA+H₂O⇄PEAH⁺+OH⁻ (11)

PEA+H₃⁺O⇄PEAH⁺+H₂O (12)

Proton Reaction of Tertiary Amine Nitrogen Atom with CO₂:

DEEA+H₂O+CO₂⇄DEEAH⁺+HCO₃⁻ (13)

### Intermolecular Interaction of Tertiary Amine and Primary Amine Nitrogen Atoms:

PEAH⁺COO⁻+DEEA⇄PEACOO⁻+DEEAH⁺ (14)

PEAH⁺+DEEA⇄PEA+DEEAH⁺ (15)

In Formula (5), PEA, a primary amine, reacts directly and quickly with CO₂ to generate a zwitterion ion, which is an amphoteric substance. In Formulas (6) to (8) and (14), the zwitterion ion reacts with water, another amine, and OH— to produce PEA carbamate (PEACOO⁻).

Unlike a primary amine, a tertiary amine does not have hydrogen bonded to the nitrogen atom, thus does not form a carbamate, but acts as a Brønsted-Lowry base catalyst to be protonated and decompose water. Decomposed water reacts with CO₂ to form a bicarbonate (HCO₃⁻).

In an embodiment of the present application, a mixture of the reaction accelerator and the main absorbent may be contained at 30 to 50 parts by weight with respect to 100 parts by weight of the carbon dioxide absorbent composition.

In an embodiment of the present application, the reaction accelerator may be contained at 1 to 10 parts by weight with respect to 100 parts by weight of the composition.

In an embodiment of the present application, the main absorbent may be contained at 30 to 50 parts by weight with respect to 100 parts by weight of the composition.

A second aspect of the present application provides a method for capturing carbon dioxide using the carbon dioxide absorbent composition, which includes introducing the composition into a reactor in a vapor liquid equilibrium (VLE) device; introducing carbon dioxide into the reactor after a temperature and a pressure in the reactor have reached equilibrium; and stirring the reactor to react the composition with carbon dioxide.

Detailed description of parts overlapping with the first aspect of the present application has been omitted, but the contents described with respect to the first aspect of the present application can be applied equally even if the description is omitted in the second aspect.

Hereinafter, the method for capturing carbon dioxide according to the second aspect of the present application will be described in detail.

In an embodiment of the present application, first, the temperature in the reactor may be maintained at 300 to 400 K, and the stirring may be performed at a speed of 800 to 1,000 rpm.

In an embodiment of the present application, the carbon dioxide absorption capacity captured by the method for capturing carbon dioxide may be 0.4 to 1.0 mole-CO₂/mole-Amine, the apparent absorption rate may be determined by the time for the reaction of the carbon dioxide absorbent composition with carbon dioxide to reach the equilibrium, and the time to reach the equilibrium may be 7 to 40 minutes, the heat of absorption of the carbon dioxide absorbent composition may be −80 to −60 kJ/mol·K, and the cyclic capacity may be 0.2 to 0.5 mole-CO₂/mole-Amine.

A third aspect of the present application provides a method for manufacturing the carbon dioxide absorbent composition, which includes mixing a reaction accelerator and a main absorbent to prepare a mixture; and stirring the mixture for activation.

Detailed description of parts overlapping with the first and second aspects of the present application has been omitted, but the contents described with respect to the first and second aspects of the present application can be applied equally even if the description is omitted in the third aspect.

In an embodiment of the present application, first, the composition may contain a main absorbent and a reaction accelerator, the main absorbent may be a tertiary alkanol amine, and the reaction accelerator may be a primary amine.

In an embodiment of the present application, a mixture of the reaction accelerator and the main absorbent may be contained at 30 to 50 parts by weight with respect to 100 parts by weight of the composition, preferably the reaction accelerator may be contained at 1 to 10 parts by weight with respect to 100 parts by weight of the composition and the main absorbent may be contained at 30 to 50 parts by weight with respect to 100 parts by weight of the composition.

Hereinafter, Examples of the present invention will be described in detail so that those skilled in the art to which the present invention pertains can easily practice the present invention. However, the present invention can be implemented in various different forms, and is not limited to Examples described here.

### Example 1: Preparation of Carbon Dioxide Absorbent Composition

### (1) Substances Prepared

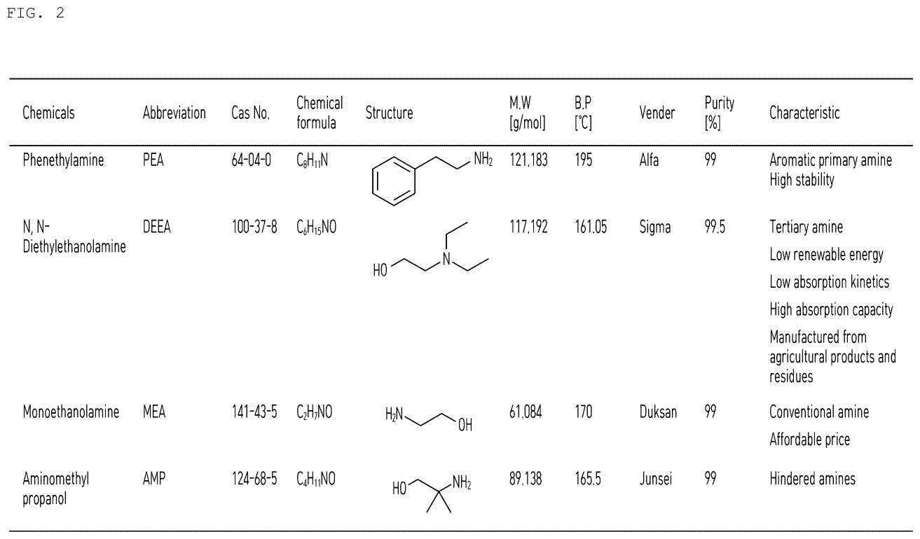

All organic amine reagents were prepared considering purity. A diethylethanolamine (DEEA) (manufacturer: Sigma Aldrich, >99.5%) solution and a phenethylamine (PEA) (manufacturer: Sigma Aldrich, >99.8%) solution were prepared. The 2-amino-2-methyl-1-propanol (AMP) (manufacturer: Sigma Aldrich, >98.0%) reagent used for the accuracy experiment of vapor-liquid equilibrium (VLE) was prepared at 30 wt %. Information and characteristics of the amines used are illustrated in FIG. 2 below.

### (2) Preparation of Composition

A composition was prepared so that the DEEA concentration was 35 wt %, the PEA concentration was 5 wt %, and the total amine concentration was 40 wt % with respect to 100 parts by weight of the composition.

The composition thus prepared was named D35P5.

### Example 2: Preparation of Carbon Dioxide Absorbent Composition

A carbon dioxide absorbent composition was prepared in the same manner as in Example 1, except that the concentration of DEEA was changed to 30 wt % and the concentration of PEA was changed to 10 wt %. The composition thus prepared was named D30P10.

### Comparative Example: Preparation of Carbon Dioxide Absorbent Composition

A composition was prepared so that the DEEA concentration was 40 wt % and the total amine concentration was 40 wt % with respect to 100 parts by weight of the composition. The prepared composition was named D40.

FIG. 3 illustrates the compositions and abbreviations of the prepared amine solutions.

### Experimental Example 1: CO₂ Absorption Experiment and ¹³C NMR Measurement

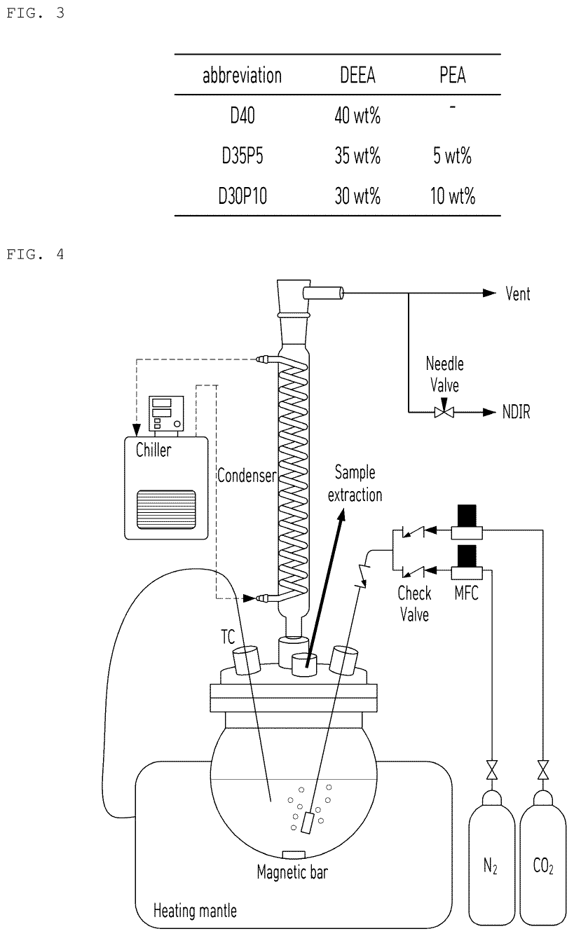

Quantitative ¹³C NMR analysis was performed to observe speciation and liquid phase behavior in CO₂-loaded amine solutions. NMR analysis is used to determine carbamate stability and liquid composition/speciation. Samples for NMR analysis were prepared using the experimental device depicted in FIG. 4. Into the reactor, 200 g of the solution was introduced, and CO₂ 15% (N₂ balance) was set at a flow rate of 1 L/min. The temperature was kept constant at 313 K using a heating mantle, and a total of 6 to 8 samples including a fresh sample were collected. Deuterium oxide, D2O (Eurisotop, 99.90%) was used for pretreatment of the collected samples for ¹³C NMR analysis, and the analysis was performed at 25° C. using BRUKER AVANCE 400 MHz. As a reference substance, 4-dioxane (Sigma Aldrich, >99.0%) was used.

CO₂ loading of the samples used in quantitative ¹³C NMR analysis was measured using a total organic carbon (TOC) analyzer. The TOC analyzer used to analyze the CO₂ content in the samples was TOC/TNb: multi N/C® (Analytik Jena, Germany).

### Experimental Example 2: Measurement of CO₂ Solubility

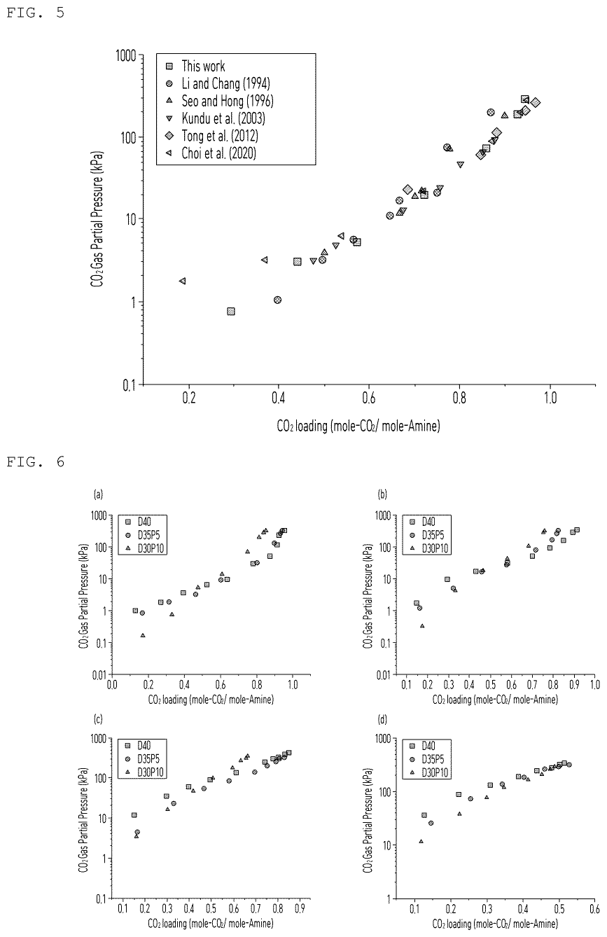

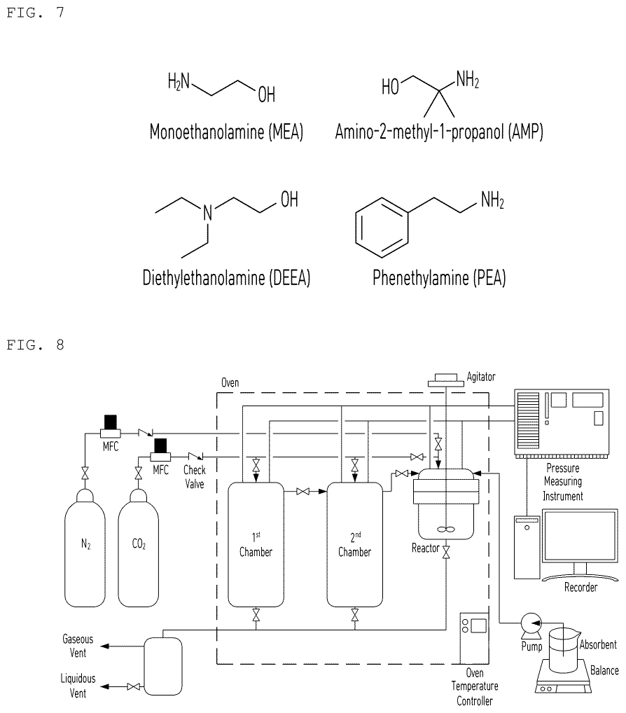

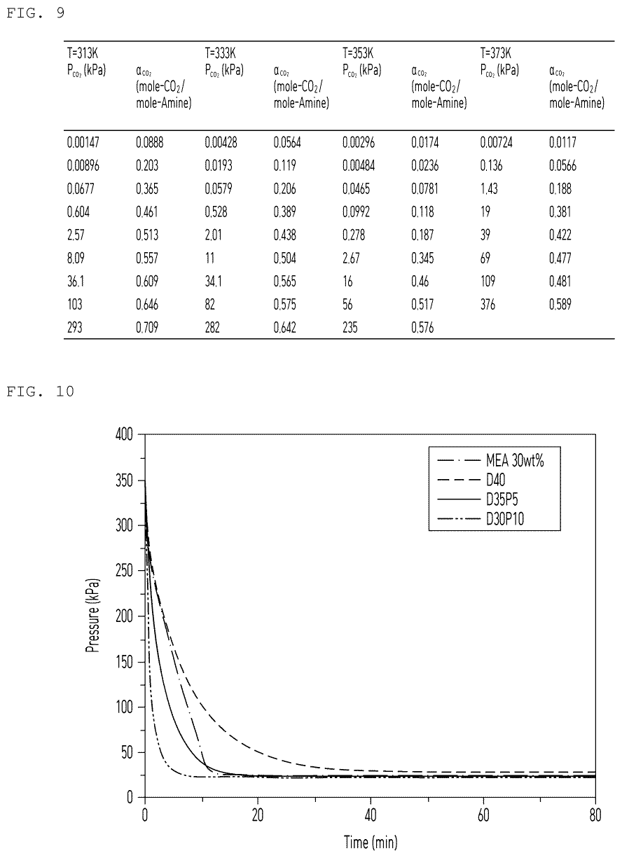

Before proceeding with the experiment, an experiment for measuring the equilibrium CO₂ solubility in an AMP 30 wt % solution was performed in order to determine the accuracy of the VLE experimental setup. FIG. 5 illustrates the measurement results of CO₂ solubility in the AMP 30 wt % solution at 313 K using a VLE experimental device. CO₂ loading represents the amount (moles) of CO₂ absorbed by 1 mole of amine. Since the experimental results in previous studies and the present invention are in good agreement, the CO₂ equilibrium solubility data measured according to an embodiment of the present invention are reliable.

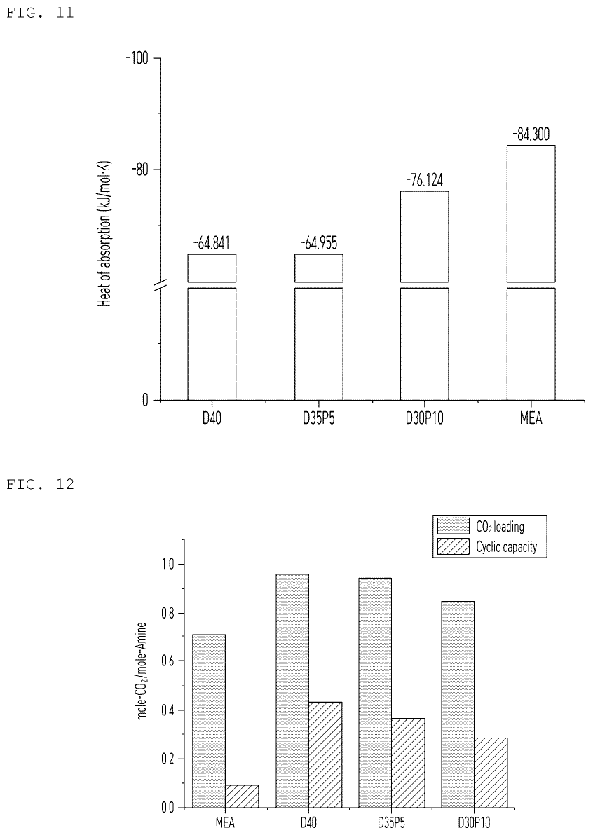

The CO₂ solubility in D40, D35P5, and D30P10 was measured at 313 K, 333 K, 353 K, and 373 K. The results of CO₂ gas partial pressure (kPa) expressed as equilibrium loading (mole CO₂/mole amine) are illustrated in FIG. 6, and the specific results are illustrated in FIG. 10.

Referring to FIG. 6, at the same CO₂ loading, a lower CO₂ equilibrium partial pressure means that the solution has a larger absorption capacity.

At 313 K, the difference in CO₂ solubility between the D40 and D35P5 solutions was not great, but D30P10 had lower final CO₂ loading than the two solutions. In (a) of FIG. 6, the final absorption capacities of D40, D35P5, and D30P10 were about 0.96, 0.94, and 0.85 mole-CO₂/mole-Amine, respectively, and D40 had the highest absorption capacity.

In (b) of FIG. 6, at 333 K, the final absorption capacities of D40, D35P5, and D30P10 were 0.91, 0.82, and 0.76 mole-CO₂/mole-Amine, respectively, and D40 had the highest absorption capacity. The final absorption capacities of D40, D35P5, and D30P10 were 0.85, 0.83, and 0.66 mole-CO₂/mole-Amine, respectively, at 353 K in (c) of FIG. 6, and 0.51, 0.53, and 0.49 mole-CO₂/mole-Amine, respectively, at 373 K in (d) of FIG. 6, and the absorption capacity was slightly higher in D35P5 than in D40, but the difference was not great. The reason why D40 has the highest absorption capacity at most temperatures is that the content of tertiary amine having a large absorption capacity is high in D40. The reason why the absorption capacity is higher when the content of tertiary amine is higher can be explained by the following reaction formulas.

2R₁NH₂+CO₂↔R₁NHCOO⁻+RNH₃⁺

R₃N+H₂O+CO₂↔R₃N⁻+HCO₃⁺

R₁NH₂ in Formula (23) represents a primary amine, and R₃N in Formula (24) represents a tertiary amine. As shown in Formulas (23) and (24), 1 mol of primary amine ultimately reacts with about 0.5 mol of CO₂, so the theoretical absorption capacity thereof is lower than that of tertiary amine, which reacts with 1 mol of CO₂ per 1 mol of amine. Therefore, as the content of primary amine decreases and the content of tertiary amine increases, the absorption capacity increases. This is also the reason why D30P10 has the lowest absorption capacity. All three blended absorbents have been found to have a much greater CO₂ solubility than MEA at each temperature compared to commercial absorbents, so the used absorbents have been confirmed to have a greater absorption capacity than commercial absorbents.

### Experimental Example 3: Measurement of Apparent Absorption Rate

The absorption rate of the composition is a greatly important parameter to determine the scale of CO₂ capture process. FIG. 10 illustrates the change in pressure due to CO₂ absorption over time after CO₂ injection into the VLE device reactor at 313 K. Therefore, the apparent CO₂ initial absorption rates of the respective compositions can be compared through the respective slopes. The apparent absorption rate of each composition was compared with that of conventional amine (MEA 30 wt %). D40 reached the equilibrium about 40 minutes after CO₂ injection. D35P5 and MEA reached the equilibrium in about 11 minutes, and D30P10 reacted the fastest and reached the equilibrium in 7 minutes. When the apparent rates from the initial reaction up to 10 minutes are compared, the order is as follows: D30P10>D35P5>MEA 30 wt %>D40. The apparent rate was determined by integrating each curve up to 10 minutes, and the composition having the smallest area was determined to be the fastest composition. According to Example of the present invention, the apparent absorption rate of the three compositions increased as the PEA content increased. This may be considered to be associated with the shuttle mechanism in which PEA, a primary amine, in the DEEA-PEA-CO₂—H₂O system forms PEA carbamate through rapid interaction at the vapor-liquid interface to quickly diffuse CO₂ into the bulk solution and increase mass transfer. This fast absorption rate can reduce the size of the reactor in the CO₂ capture process.

### Experimental Example 4: Measurement of Heat of Absorption

Carbamates generated when the absorption rate is increased by primary amines require more heat energy to regenerate free amines and CO₂. Therefore, the heat of absorption was calculated to estimate the heat required for CO₂ desorption. The heat of CO₂ absorption of each absorbent was calculated using Gibbs-Helmholtz (G-H) Equation (21). The CO₂ equilibrium loading was measured at various pressures and 313 K, 333 K, 353 K, and 373 K.

ln P_{CO2} versus 1/T is illustrated in FIG. 11. The CO₂ equilibrium loading for calculation of the heat of reaction of D40, D35P5, and D30P10 is 0.5 mole-CO₂/mole-amine, respectively, and the slope of the fitting leaner line is −7799.02, −7812.68, and −9156.10, respectively. Table 1 shows estimates of the heat of reaction of MEA 30 wt %, D40, D35P5, and D30P10. The estimated results of the heat of absorption of D40, D35P5, and D30P10 are −64.84, −64.95, −76.12 kJ/mol·Kv, respectively. The reason for such results is that more energy is required to break the C—N single bond of carbamate, so it can be assumed that the heat of desorption (or heat of absorption) of D30P10, which forms a large amount of carbamate, is measured to be the highest. However, the heat of absorption of all of D40, D35P5, and D30P10 was lower that the heat of absorption −84.3 kJ/mol·K of MEA 30 wt % by 23.08%, 22.95%, and 9.70%, respectively. Therefore, energy can be saved in solvent regeneration as the heat of absorption is lower than that of MEA 30 wt %, a commercial absorbent.

TABLE 1

| | Heat of | CO₂ equilibrium | Cyclic capacity |
|---|---|---|---|
| | absorption | loading [mole- | [mole-CO₂/ |
| Absorbent | [kJ/mol · K] | CO₂/mole-amine] | mole-amine] |
| MEA | −64.8411 | 0.709 | 0.089728 [32] |
| D40 | −64.9546 | 0.955543 | 0.429734 |
| D35P5 | −76 | 0.941496 | 0.359988 |
| D30P10 | −84.3 [5] | 0.850997 | 0.284286 |

### Experimental Example 5: Measurement of Cyclic Capacity

A high cyclic capacity reduces the loss of sensible heat among the energy required for regeneration and the circulation flow rate of the absorbent, thereby reducing the scale of regeneration process. Therefore, a composition having a higher cyclic capacity is required to be selected in the process. The cyclic capacity was calculated as the difference between rich loading and lean loading at 15 kPa and 313 K to 373 K. The calculated cyclic capacity values are shown in Table 1 and FIG. 12. FIG. 12 illustrates a schematic diagram for comparing the absorption capacity (CO₂ equilibrium loading) and cyclic capacity of three compositions and MEA 30 wt %. For comparison with commercial absorbents, the cyclic capacity of MEA 30 wt % was derived using Equation 21. The composition having the highest cyclic capacity was D40 (0.4297 mole-CO₂/mole-Amine), and all three compositions had higher values than MEA 30 wt % (0.0897 mole-CO₂/mole-Amine). D40, D35P5, and D30P10 had a cyclic capacity higher than that of MEA 30 wt % by about 79.12%, 75.07%, and 68.44%, respectively. As the content of PEA increased, the absorption capacity and cyclic capacity tended to decrease, but the absorption capacity and cyclic capacity of all three compositions were higher than those of MEA 30 wt %.

Therefore, the three compositions according to an embodiment of the present invention can lower the loss of sensible heat compared to when MEA 30 wt % is used in the regeneration process.

### Experimental Example 6: ¹³C NMR Analysis and Speciation

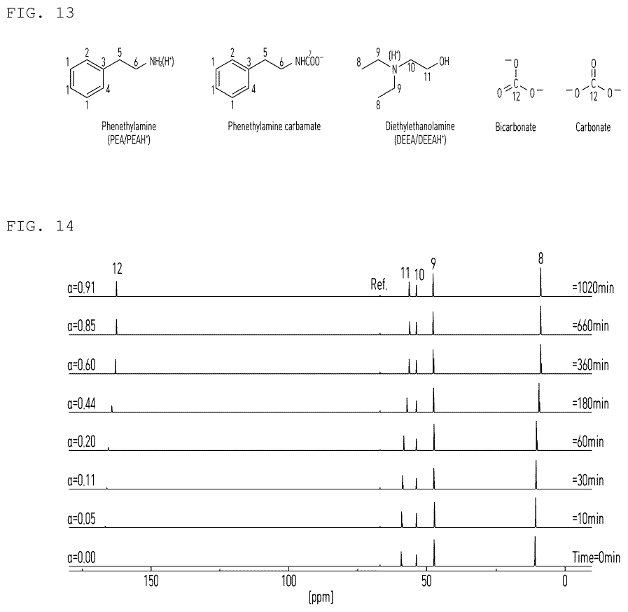

Based on the reaction mechanism among amines, CO₂ and H₂O, the molecules that can be produced in the CO₂-loaded DEEA-CO₂—H₂O system are DEEA, DEEAH⁺, HCO₃ and CO₃². Meanwhile, the molecules that can be produced in the DEEA-PEA-CO₂—H₂O system are DEEA, DEEAH⁺, PEA, PEAH⁺, PEA carbamate (PEACOO⁻), HCO₃ and CO₃². The structures of the molecules that can be produced are illustrated in FIG. 13. The carbon atoms in each molecule were assigned numbers corresponding to each peak in the spectra.

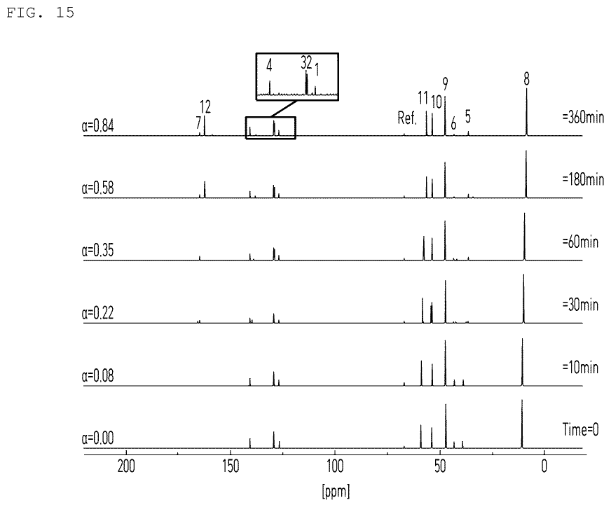

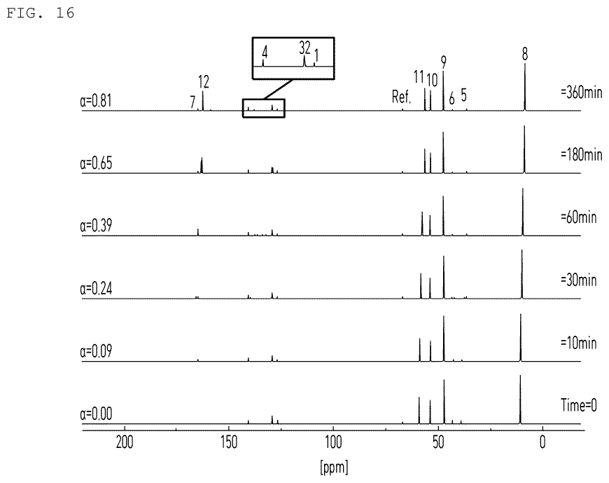

The peaks of the respective species in the ¹³C NMR spectrum for the DEEA-CO₂—H₂O system (DEEA 40 wt %) are illustrated in FIG. 14. The reference substance, 1,4-dioxane was observed at δ=67.00 ppm. The DEEA/DEEAH⁺ peaks appeared at δ=59.24; 53.89; 47.28; and 10.77 ppm. The peaks of two secondary carbons (—CH₂OH and —CH₂—) appeared at signals 10 (δ=53.89 ppm) and 11 (δ=59.24 ppm), respectively, in FIG. 14, and the average peak for two different secondary carbons is shown at signal 9 (δ=47.28 ppm). In addition, two methyl groups ((—CH₃)₂) are shown at signal 8 (δ=10.77 ppm). As expected, a new peak (δ=166.57 ppm, signal 12) appeared 30 minutes after CO₂ injection (α=0.11 mol-CO₂/mol-amine), and this peak is assigned to carbonate/bicarbonate. In the ¹³C NMR spectrum, there is only one peak attributed to a bicarbonate and a carbonate, which are indistinguishable from each other because of the rapid proton exchange therebetween. In FIG. 13, it was observed that the relative intensity of carbonate/bicarbonate in the solution gradually increased when the carbon dioxide concentration (CO₂ loading) in the solution was increased from α=0.05 to 0.91 mol-CO₂/mol-amine. The carbonate/bicarbonate peak shifted slightly toward a lower frequency as the intensity increased, and this implies that the absorbed CO₂ is present in the form of a bicarbonate as the solution approaches the equilibrium. Since DEEA is a tertiary amine not having a hydrogen atom bonded to nitrogen, additional peaks are not observed except for carbonate/bicarbonate when CO₂ is loaded into the system. Therefore, the reaction products in the DEEA-CO₂—H₂O system (DEEA 40 wt %) system are only carbonate/bicarbonate species and amines/protonated amines. The ¹³C NMR chemical shifts of DEEA single absorbent are illustrated in FIG. 17. FIG. 17 describes the chemical shifts and peak areas in ¹³C NMR spectra of the respective solutions at 25° C.

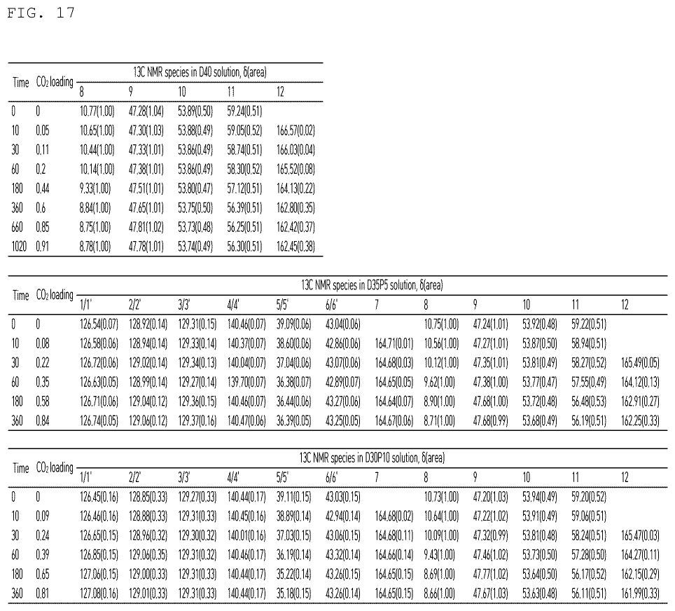

The ¹³C NMR spectra for the DEEA-PEA-CO₂—H₂O system are illustrated in FIGS. 15 and 16. The reference substance, 1,4-dioxane was observed at δ=66.99 ppm. In FIG. 15, the peak attributed to PEA/PEAH⁺ and the peak attributed to DEEA/DEEAH⁺ appear in the spectrum before CO₂ loading. The DEEA/DEEAH⁺ peaks appeared at δ=59.20; 53.94; 47.20; and 10.73 ppm, and the PEA/PEAH⁺ peaks appeared at δ=39.09; 43.04; 126.54; 128.92; 129.31; and 140.46 ppm. The carbon of the phenyl group facing the ethyl group of PEA is assigned to signal 1 (δ=126.54 ppm). The average peak of carbon on both sides of carbon number 1 was assigned to signal 2 (δ=128.85 ppm), and the average peak of carbon on both sides of carbon number 2 was assigned to signal 3 (δ=129.27 ppm). The last carbon of the phenyl group is assigned to signal 4 (δ=140.44 ppm). The two secondary carbons (—CH₂— and —CH₂NH₂) of PEA are shown as signals 5 (δ=39.11 ppm) and 6 (δ=43.03 ppm), respectively.

Referring to FIG. 15, a PEA carbamate (PEACOO⁻) peak and a carbonate/bicarbonate peak appeared after CO₂ injection. The PEA carbamate peak at α=0.08 mol-CO₂/mol-amine corresponds to signal 7 (δ=164.71 ppm). As CO₂ loading increases from α=0.08 to 0.35 mol-CO₂/mol-amine, the relative intensity of the PEA carbamate peak increases. However, it was observed that the relative intensity of the PEA carbamate signal decreased although the CO₂ loading increased from α=0.35 to 0.84 mol-CO₂/mol-amine. This may be inferred that the PEA carbamate is exhausted since the reaction of CO₂ with PEA is slower than the speed at which the PEA carbamate formed at the solution interface acts as a shuttle to transfer CO₂. The carbonate/bicarbonate peak (signal 12, δ=165.49 to 162.25 ppm) was observed to appear after the PEA carbamate peak appeared. The relative intensity of the carbonate/bicarbonate peak increased as CO₂ loading increased from α=0.08 to 0.84 mol-CO₂/mol-amine. The ¹³C NMR spectrum of the DEEA-PEA-CO₂—H₂O system suggests that the reaction path between CO₂ and amines follows the previously proposed reaction mechanism and the reaction activity of PEA with CO₂ is higher than that of DEEA with CO₂. Therefore, the DEEA+PEA blended absorbent has a faster CO₂ absorption rate than the DEEA single absorbent. The relative intensity of carbonate/bicarbonate increases as the CO₂ concentration in the solution increases. The ¹³C NMR chemical shifts and areas of the blended absorbent D35P5 are shown in Table 5. The carbonate/bicarbonate peak (signal 12) increased in intensity and shifted to a lower frequency (δ=162.25 ppm) as the CO₂ concentration in the solution increased.

Referring to FIG. 16, the ¹³C NMR spectrum of D30P10 before CO₂ injection is similar to that of D35P5. However, the intensity of peaks (signals 1 to 6) corresponding to PEA in D30P10 is greater than that in D35P5 because of the increased PEA content. The reference substance, 1,4-dioxane was observed at δ=66.99 ppm, the DEEA/DEEAH⁺ peaks appeared at δ=59.20; 53.94; 47.20; and 10.73 ppm, and the PEA/PEAH⁺ peaks appeared at δ=39.09; 43.04; 126.54; 128.92; 129.31; and 140.46 ppm. In the sample (α=0.09 mol-CO₂/mol-amine) reacted for 10 minutes after CO₂ injection, the PEA carbamate peak appeared at δ=164.68 ppm. Afterwards, the bicarbonate/carbonate peak was observed at δ=165.47 ppm in the sample (α=0.24 mol-CO₂/mol-amine) reacted for 30 minutes. The bicarbonate/carbonate peak increased in intensity and shifted to lower frequencies (δ=16547 to 161.99 ppm) as CO₂ loading in the absorbent increased from α=0.09 to 0.81 mol-CO₂/mol-amine.

Regarding the area of ¹³C NMR chemical shift of PEA carbamate (signal 7) in FIG. 17, the area of PEA carbamate in D30P10 is larger among the samples of D35P5 and D30P10 collected at 30 to 360 minutes, and it can be seen that the carbamate content in D30P10 is higher. As CO₂ loading increases, the difference in carbamate content becomes more evident. As the content of PEA increases, the amount of PEA that reacts directly with CO₂ at the gas-liquid interface increases, and a more amount of PEA carbamate is formed. Unlike DEEA single absorbent, in the DEEA-PEA blended absorbent, PEA carbamate acts as a shuttle to diffuse CO₂ into the bulk solution and transfer CO₂ to DEEA, a tertiary amine, so mass transfer increases and the reaction rate increases as the content of PEA increases.

In the VLE experiment, the CO₂ solubility in three absorbents was measured at the respective temperatures of 313 K, 333 K, and 353 K. As a result, there was no significant difference in the final CO₂ equilibrium loading capacity between DEEA 40 wt % and DEEA 35 wt %+PEA 5 wt % at the three temperatures (0.96 and 0.94 mole-CO₂/mole-Amine), and the CO₂ loading of the DEEA 30 wt %+PEA 10 wt % solvent was found to slightly decrease (0.85 mole-CO₂/mole-Amine) when a more amount of PEA was added. The apparent absorption rate was compared through changes in pressure during the first 10 minutes after CO₂ was injected into the reactor containing the absorbent. In the order of fastest to slowest apparent absorption rate, the absorbents are arranged as follows: D30P10>D35P5>MEA 30 wt %>D40. The cyclic capacity was calculated using CO₂ solubility measured at 313 K and 373 K. All three absorbents had a significantly higher cyclic capacity than a commercial absorbent MEA 30 wt %, and the absorbent having the highest cyclic capacity was D40.

These amine absorbents were analyzed using a ¹³C NMR spectrometer. The main products quantified are as follows: DEEA, DEEAH⁺, HCO₃ and CO₃² in the case of DEEA-CO₂—H₂O system and DEEA, DEEAH⁺, PEA, PEAH⁺, PEA carbamate (PEACOO⁻), HCO₃ and CO₃² in the case of DEEA-PEA-CO₂—H₂O system. In the case of DEEA-CO₂—H₂O system, only the peak attributed to DEEA appeared before CO₂ injection, but not only the DEEA(H⁺) peak but also the carbonate/bicarbonate peak were additionally observed at α=0.05 mole-CO₂/mole-amine after CO₂ injection. The carbonate/bicarbonate peak increased in intensity as CO₂ loading increased. In the case of DEEA-PEA-CO₂—H₂O system, DEEA and PEA peaks were observed before CO₂ injection, but the PEA carbamate (PEA-COO) and carbonate/bicarbonate peaks were additionally observed together with the DEEA(H⁺) and PEA(H⁺) peaks after CO₂ injection. As CO₂ loading increased, not only the intensity of the PEA carbamate peak but also the intensity of the carbonate/bicarbonate peak increased. The area of PEA carbamate peak in D30P10 is larger than that in D35P5, so the PEA carbamate content in D30P10 is obviously higher than that in D35P5. As the PEA content increases, the amount of PEA carbamate produced through a direct reaction of PEA with CO₂ at the gas-liquid interface increases. Since PEA carbamate diffuses CO₂ into the bulk solution and transfers CO₂ to DEEA, a tertiary amine, mass transfer increases as the content of PEA increases, and the reaction rate thus increases.

According to an embodiment of the present invention, it is possible to provide a composition, which exhibits excellent CO₂ capture performance and has a higher absorption rate, a higher absorption capacity, and lower heat of absorption than an absorbent used in the conventional CO₂ capture process by combining a tertiary alkanol amine and a primary amine containing an aromatic ring, and a method for manufacturing the same.

According to an embodiment of the present invention, diethylethanolamine (DEEA) can be manufactured from agricultural products or residues, which are renewable resources, so the final absorbent can be manufactured at low cost, and the present invention can be usefully used as a technology that can reduce energy demand in the field of CO₂ capture and storage.

The effects of the present invention are not limited to the effects described above, and should be understood to include all effects that can be inferred from the configuration of the invention described in the description or claims of the present invention.

The foregoing description of the present invention is for illustrative purposes only, and those skilled in the art to which the present invention pertains will understand that the present invention can be easily modified into other specific forms without changing its technical idea or essential features. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

What is claimed is:

1. A carbon dioxide absorbent composition comprising:
a main absorbent; and
a reaction accelerator,
wherein the main absorbent is a tertiary alkanol amine, and
the reaction accelerator is a primary amine.

2. The carbon dioxide absorbent composition according to claim 1,
wherein the primary amine contains an aromatic ring.

3. The carbon dioxide absorbent composition according to claim 1,
wherein the primary amine is represented by RNH₂, where R is a substituted or unsubstituted aliphatic hydrocarbon group or a substituted or unsubstituted aromatic hydrocarbon group, and
the substituent is any one of an alkyl group, an aryl group, an alkoxy group, an aryloxy group, an acyloxy group, a halogen atom, an acylamino group, an acyl group, an alkylthio group, an arylthio group, a hydroxy group, a cyano group, an alkyloxycarbonyl group, an aryloxycarbonyl group, a substituted carbamoyl group, a substituted sulfamoyl group, a nitro group, a substituted amino group, an alkylsulfonyl group, an arylsulfonyl group, a substituted alkylsulfonamide group, or a substituted arylsulfonamide group.

4. The carbon dioxide absorbent composition according to claim 1,
wherein the tertiary alkanol amine has a pKa value in a range of 7.0 to 11.0.

5. The carbon dioxide absorbent composition according to claim 1,
wherein the tertiary alkanol amine is selected from the group consisting of N,N-bis-(3-dimethylaminopropyl)-N-(2-hydroxypropyl-octadecyl ether)amine, N-(3-dimethylaminopropyl)-N-(2-hydroxypropyl-octadecyl ether)amine, N,N-bis-(3-dimethylaminopropyl)-N-(2-hydroxypropyl-hexadecyl ether)amine, N-(3-dimethylaminopropyl)-N-(2-hydroxypropyl-hexadecyl ether)amine, N,N-bis-(3-dimethylaminopropyl)-N-(2-hydroxypropyl-tetradecyl ether)amine, N-(3-dimethylaminopropyl)-N-(2-hydroxypropyl-tetradecyl ether)amine, N,N-bis-(3-dimethylaminopropyl)-N-(2-hydroxypropyl-dodecyl ether)amine, N-(3-dimethylaminopropyl)-N-(2-hydroxypropyl-dodecyl ether)amine, N,N-bis-(3-dimethylaminopropyl)-N-(2-hydroxypropyl-decyl ether)amine, N-(3-dimethylaminopropyl)-N-(2-hydroxypropyl-decyl ether)amine, N,N-bis-(3-dimethylaminopropyl)-N-(2-hydroxypropyl-octyl ether)amine, N-(3-dimethylaminopropyl)-N-(2-hydroxypropyl-octyl ether)amine, N,N-bis-(3-dimethylaminopropyl)-N-(2-hydroxypropyl-2-ethylhexyl ether)amine, N-(3-dimethylaminopropyl)-N-(2-hydroxypropyl-2-ethylhexyl ether)amine, N,N-bis-(3-dimethylaminopropyl)-N-(2-hydroxypropyl-hexyl ether)amine, N-(3-dimethylaminopropyl)-N-(2-hydroxypropyl-hexyl ether)amine, N,N-bis-(3-dimethylaminopropyl)-N-(2-hexanol)amine, N-(3-dimethylaminopropyl)-N-(2-hexanol)amine, N,N-bis-(3-dimethylaminopropyl)-N-(2-octanol)amine, N-(3-dimethylaminopropyl)-N-(2-octanol)amine, N,N-bis-(3-dimethylaminopropyl)-N-(2-decanol)amine, N-(3-dimethylaminopropyl)-N-(2-decanol)amine, N,N-bis-(3-dimethylaminopropyl)-N-(2-dodecanol)amine, N-(3-dimethylaminopropyl)-N-(2-dodecanol)amine, N,N-bis-(3-dimethylaminopropyl)-N-(2-tetradecanol)amine, N-(3-dimethylaminopropyl)-N-(2-tetradecanol)amine, N,N-bis-(3-dimethylaminopropyl)-N-(2-hexadecanol)amine, N-(3-dimethylaminopropyl)-N-(2-hexadecanol)amine, N,N-bis-(3-dimethylaminopropyl)-N-(2-octadecanol)amine, N-(3-dimethylaminopropyl)-N-(2-octadecanol)amine, N,N-bis-(3-dimethylaminopropyl)-N-(2-hydroxypropyl-butyl ether)amine, N,N-bis-(3-dimethylaminopropyl)-N-(2-hydroxypropylneodecanoic acid ester)amine, N-methyldiethanolamine, dimethylethanolamine, N,N-diethylethanolamine, triethanolamine, and mixtures thereof.

6. The carbon dioxide absorbent composition according to claim 1,
wherein a mixture of the reaction accelerator and the main absorbent is contained at 30 to 50 parts by weight with respect to 100 parts by weight of the composition.

7. The carbon dioxide absorbent composition according to claim 6,
wherein the reaction accelerator is contained at 1 to 10 parts by weight with respect to 100 parts by weight of the composition.

8. The carbon dioxide absorbent composition according to claim 6,
wherein the main absorbent is contained at 30 to 50 parts by weight with respect to 100 parts by weight of the composition.

9. A method for capturing carbon dioxide, the method comprising:
introducing the carbon dioxide absorbent composition of claim 1 into a reactor in a vapor liquid equilibrium (VLE) device;
introducing carbon dioxide into the reactor after a temperature and a pressure in the reactor have reached equilibrium; and
stirring the reactor to react the composition with carbon dioxide.

10. The method for capturing carbon dioxide according to claim 9,
wherein the temperature in the reactor is maintained at 300 to 400 K, and
the stirring is performed at a speed of 800 to 1,000 rpm.

11. The method for capturing carbon dioxide according to claim 9,
wherein a carbon dioxide absorption capacity captured by the method for capturing carbon dioxide of claim 9 is 0.4 to 1.0 mole-CO₂/mole-Amine,
an apparent absorption rate is determined by time for a reaction of the carbon dioxide absorbent composition with carbon dioxide to reach equilibrium, and the time to reach equilibrium is 7 to 40 minutes,
heat of absorption of the carbon dioxide absorbent composition is −80 to −60 kJ/mol·K, and
a cyclic capacity is 0.2 to 0.5 mole-CO₂/mole-Amine.

12. A method for manufacturing the carbon dioxide absorbent composition of claim 1, the method comprising:
mixing a reaction accelerator and a main absorbent to prepare a mixture; and
stirring the mixture for activation.

13. The method for manufacturing a carbon dioxide absorbent composition according to claim 12,
wherein the composition contains a main absorbent and a reaction accelerator,
the main absorbent is a tertiary alkanol amine, and
the reaction accelerator is a primary amine.

14. The method for manufacturing a carbon dioxide absorbent composition according to claim 12,
wherein a mixture of the reaction accelerator and the main absorbent is contained at 30 to 50 parts by weight with respect to 100 parts by weight of the composition.
